(19) United States
(12) Patent Application Publication
(10) Pub. No.: US 2026/0099935 A1
(43) Pub. Date: Apr. 9, 2026

(54) TEMPERATURE DETECTION APPARATUS AND METHOD

(71) Applicant: NANYA TECHNOLOGY CORPORATION, New Taipei City (TW)

(72) Inventors: Sun-Fu CHOU, New Taipei City (TW); Chi Ming PAN, New Taipei City (TW); Wen Ching YU, New Taipei City (TW); Jih-Cheng HUANG, New Taipei City (TW)

(21) Appl. No.: 18/906,159

(22) Filed: Oct. 3, 2024

(51) Int. Cl. G06T 7/564; G06T 1/00; G06T 7/62

(52) U.S. Cl. CPC G06T 7/564; G06T 1/0007; G06T 7/62; G06T 2207/10048; G06T 2207/20212

(57) ABSTRACT

A temperature detection apparatus and method are provided. The apparatus captures an image and a thermal image of an object. The apparatus determines a first contour of the object in the image based on the image. The apparatus overlaps the first contour in the image onto the thermal image to generate a second contour in the thermal image. The apparatus generates a temperature record of the object based on a plurality of temperature values among the second contour in the thermal image.

### BACKGROUND

### Field of Invention

The present disclosure relates to a temperature detection apparatus and method. More particularly, the present disclosure relates to a temperature detection apparatus and method based on images.

### Description of Related Art

Temperature detection technology is applied in various scenarios. Operations such as equipment maintenance, system monitoring, and fault detection need to be completed through temperature detection.

However, the prior art must rely on personnel to hold a thermometer to measure the temperature, interpret the data, and record the temperature readings. This reliance on manual operation leads to high operating costs and possible misjudgments.

In view of this, how to provide a reliable and efficient temperature detection technology is the goal that the industry strives to work on.

### SUMMARY

The disclosure provides a temperature detection apparatus. The temperature detection apparatus comprises a camera and a processor. The camera is configured to capture an image and a thermal image of an object. The processor is coupled to the camera and configured to execute the following operations: determining a first contour of the object in the image based on the image; overlapping the first contour in the image onto the thermal image to generate a second contour in the thermal image; and generating a temperature record of the object based on a plurality of temperature values among the second contour in the thermal image.

The disclosure further provides a temperature detection method. The temperature detection method is adapted for use in an electronic apparatus, wherein the temperature detection method comprises the following steps: capturing an image and a thermal image of an object; determining a first contour of the object in the image based on the image; overlapping the first contour in the image onto the thermal image to generate a second contour in the thermal image; and generating a temperature record of the object based on a plurality of temperature values among the second contour in the thermal image.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a temperature detection apparatus according to a first embodiment of the present disclosure.

FIG. 2 is a flow diagram illustrating the temperature detection apparatus detecting an object temperature according to some embodiments of the present disclosure.

FIG. 3 is a schematic diagram illustrating a contour template and a mark according to some embodiments of the present disclosure.

FIG. 4 is a schematic diagram illustrating a user interface according to some embodiments of the present disclosure.

FIG. 5 is a flow diagram illustrating a temperature detection method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

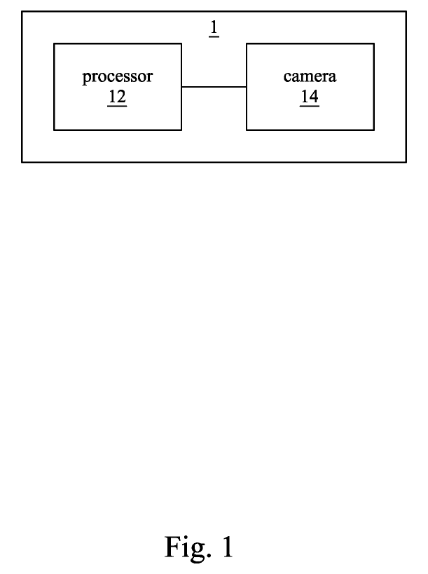

Please refer to FIG. 1, which is a schematic diagram illustrating a temperature detection apparatus 1 according to a first embodiment of the present disclosure. The temperature detection apparatus 1 comprises a processor 12 and a camera 14, wherein the processor 12 electrically connects to the camera 14. The temperature detection apparatus 1 is configured to record temperature of an object based on an image and a thermal image of the object, wherein the object may be a facility, a component of a facility, or part of the component or the facility (e.g., electrical relay).

In some embodiments, the processor 12 comprises a central processing unit (CPU), a graphics processing unit (GPU), a multi-processor, a distributed processing system, an application specific integrated circuit (ASIC), and/or a suitable processing unit.

The camera 14 is configured to capture an image and a thermal image of an object. The object image is configured to show the appearance of the object, e.g., RGB image, greyscale image, black and white image, and infrared image. In some embodiments, the image comprises multiple pixels representing color values. The thermal image is configured to record thermal signals of the object and its surroundings. In some embodiments, the thermal image comprises multiple pixels representing temperature values.

In some embodiments, the camera 14 comprises an image capture circuit which is able to capture images and thermal images simultaneously. In some embodiments, the camera 14 comprises an image capture circuit and a thermal image capture circuit, wherein the image capture circuit is configured to capture images, and the thermal image capture circuit is configured to capture thermal images.

In some embodiments, the camera 14 comprises a data access circuit configured to capture images, a video camera, or a camera capable of taking images continuously. For example, the camera 14 comprises a digital single-lens reflex camera (DSLR), a digital video camera (DVC), or a near-infrared camera (NIRC).

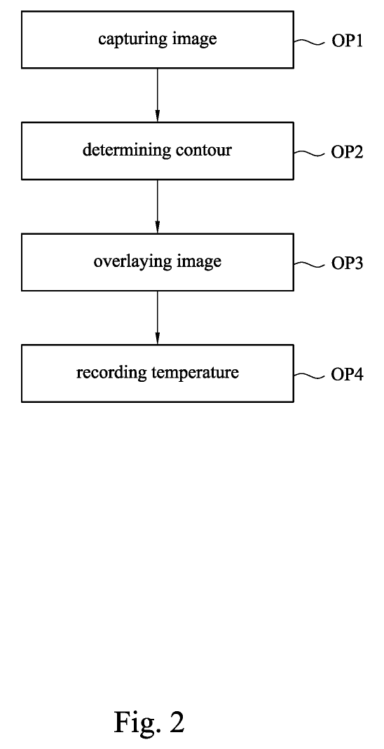

About the operations of the temperature detection apparatus 1 detecting object temperatures, please refer to FIG. 2, which is a flow diagram illustrating the temperature detection apparatus 1 detecting an object temperature according to some embodiments of the present disclosure.

First, in operation OP1, the temperature detection apparatus 1 captures an image and a thermal image of an object. Specifically, the camera 14 captures images of the object, comprising capturing an image and a thermal image of an object.

Next, in operation OP2, the temperature detection apparatus 1 recognizes the position of the object in the image and generates a contour of the object at the position. Specifically, the processor 12 determines a first contour of the object in the image based on the image.

Next, in operation OP3, the temperature detection apparatus 1 overlaps the contour of the object onto the corresponding position in the thermal image to confirm the contour position of the object in the thermal image. Specifically, the processor 12 overlaps the first contour in the image onto the thermal image to generate a second contour in the thermal image.

Finally, in operation OP4, the temperature detection apparatus 1 records the temperature of the object based on the contour position of the object in the thermal image. Specifically, the processor 12 generates a temperature record of the object based on a plurality of temperature values among the second contour in the thermal image.

Accordingly, after recognizing the object position in the image, the temperature detection apparatus 1 is able to confirm the object position in the thermal image and further record the object temperature by the one or more temperature values at the corresponding position in the thermal image.

In some embodiments, after recognizing the object position, the temperature detection apparatus 1 records the temperature of a specific component based on the relative position of the component on the object.

Specifically, the operation of generating the temperature record of the object further comprises: the processor 12 selecting a component temperature from the one or more temperature values in a contour template based on a component relative position of the object; and the processor 12 generating the temperature record based on the component temperature.

For example, while detecting the temperature of the power switch on the upper right corner of a power relay, after recognizing the object position, the temperature detection apparatus 1 records the temperature of the power switch based on the one or more temperature values in among the object contour (i.e., the second contour) in the thermal image.

In some embodiments, the temperature detection apparatus 1 recognizes the object position in the image by using a machine learning model, wherein the machine learning model is an image recognition model trained by object images. Specifically, the operation of determining the first contour of the object in the image further comprises: the processor 12 recognizing an object image in the image by using an image recognizing model; and the processor 12 generating the first contour on the object image.

For example, the processor 12 inputs an object image into a machine learning model, and then the machine learning model frames the object position in the image, wherein the framed position is the object image. Accordingly, the temperature detection apparatus 1 may further generate the contour of the object in a relative smaller range of the object image.

In some embodiments, after framing the object image, the processor 12 of the temperature detection apparatus 1 overlaps a contour template onto the object image to generate the first contour, wherein the contour template is a preset object contour, e.g., the outline of a power relay.

In some embodiments, the temperature detection apparatus 1 further comprises a storage (not shown in the figures) electrically connected to the processor 12, and the storage is configured to store the contour template.

In some embodiments, when the temperature of a certain area or component of an object needs to be record, the temperature detection apparatus 1 confirms the position of the certain area or component in the thermal image by a mark on the contour template and further record the corresponding temperature.

Specifically, the processor 12 the operation of generating the temperature record of the object further comprises: the processor 12 retrieving a component temperature corresponding to a mark in the contour template from the temperature values based on the mark in the contour template; and the processor 12 generating the temperature record based on the component temperature.

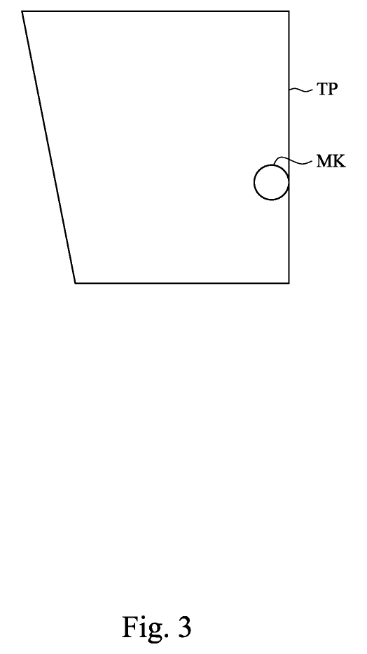

Please refer to FIG. 3, which is a schematic diagram illustrating a contour template TP and a mark MK according to some embodiments of the present disclosure. The contour template TP is the outline of the object, and the mark MK marks a certain area or component of the object. For example, while monitoring the temperature of the power relay, a certain wire contact of the power relay is prone to overheating due to wire detachment. Therefore, the mark MK in the contour template TP of the power relay marks the relative position of the wire contact on the power relay (the right position as shown in FIG. 3). When the temperature detection apparatus 1 frames the object position in the thermal image by the contour template TP, the temperature detection apparatus 1 is able to confirm the position of the wire contact and record and monitor the temperature of the wire contact.

In some embodiments, in order to save computing resources, before determining the contour of the object (i.e., the first contour) in the image, the temperature detection apparatus 1 determines whether the object has been clearly captured by the image. Only execute the following contour-determining operation after confirming that the object image in the image has a certain degree of integrity and clarity. Otherwise, if the object image in the image is incomplete, blurry, or even not capture the object, the temperature detection apparatus 1 does not execute the following contour-determining operation.

Specifically, the operation of determining the first contour of the object in the image further comprises: the processor 12 calculating a similarity between the image and a contour template based on the contour template; and in response to the similarity being lower than a threshold, the processor 12 not determining the first contour of the object in the image.

For example, the temperature detection apparatus 1 compares the image captured by the camera 14 with an object contour or a pre-obtained object image through Automated Optical Inspection (AOI) and calculates the similarity between the two. The similarity represents the reliability of whether the object has captured by the image, and also represents the clarity and/or integrity of the object captured by the image. Accordingly, the temperature detection apparatus 1 is able to determine whether to execute the following operation to improve computing efficient through determining whether the similarity exceeds a threshold (e.g., 80%).

In some embodiments, the temperature detection apparatus 1 also provide a user interface configured to indicate the user to adjust the shooting direction of the camera 14 to make the image and the thermal image captured are able to display the object completely.

Specifically, the operation of determining the first contour of the object in the image further comprises: the processor 12 displaying a user interface, wherein the user interface comprises the image and a contour template; and the processor 12 receiving an operating input corresponding to the user interface, adjusting a field of view (FOV) of the camera capturing the image to determine the first contour.

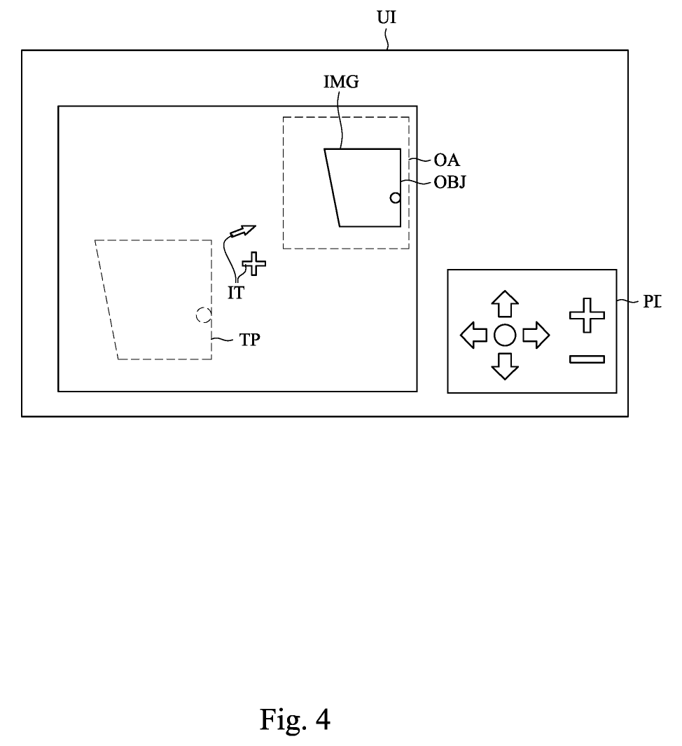

Please refer to FIG. 4, which is a schematic diagram illustrating a user interface UI according to some embodiments of the present disclosure. As shown in the figure, the user interface UI comprises the live image IMG captured by the camera 14 and the contour template TP overlaid on the image IMG. Through the user interface UI, the user is able to compare whether the object OBJ has been completely photographed with the contour template TP.

Furthermore, the user interface UI further comprises an operating area PD, the user may adjust the field of view and zoom of the camera 14 through interacting with the buttons in the operating area PD (i.e., the operating input). Accordingly, the user may moves the field of view of the camera 14, zooms the image based on the user interface UI, and then places the object OBJ at the position of the contour template TP.

Additionally, the temperature detection apparatus 1 may also recognize the position where the object may appears in the image IMG and then instructs the user to adjust the field of view and zoom of the camera 14 via the user interface UI.

Specifically, wherein the operation of determining the first contour of the object in the image further comprises: the processor 12 calculating an area of the object placed in the image based on the image; and the processor 12 displaying an indicator in the user interface to guide a user to move the contour template to the area.

As shown in FIG. 4, after recognizing that the object OBJ may appear in an area OA in the image IMG, the temperature detection apparatus 1 displays one or more indicators IT in the user interface UI to instruct the user to adjust the field of view to the upper right and zoom in the image in order to make the object OBJ in the image IMG is able to overlapping with the contour template TP. In some embodiments, the temperature detection apparatus 1 recognizes the object OBJ in the image IMG by using an image recognition model and generates the area OA.

In some embodiments, the temperature detection apparatus 1 further comprises a display screen to display the user interface UI.

In some embodiments, the temperature detection apparatus 1 further selects the contour template TP needed based on a positioning signal.

Specifically, the processor 12 selects one of a plurality of candidate templates as the contour template based on positioning information corresponding to the temperature detection apparatus.

For example, the temperature detection apparatus 1 confirms that it is in an engine room by the positioning information. Furthermore, the temperature detection apparatus 1 selects the contour template of the power relay configured in the engine room and executes the aforementioned operation correspondingly.

In some embodiments, in the case of the camera 14 capturing the image by the image capture circuit and capturing the thermal image by the thermal image capture circuit respectively, in order to confirm the positional relationship between the image and the thermal image, the temperature detection apparatus 1 overlaps the first contour in the image onto the thermal image based on the relative position between the image capture circuit and the thermal image capture circuit.

Specifically, the operation of overlapping the first contour in the image onto the thermal image further comprises: the processor 12 determining a position of the first contour in the thermal image based on a positional relationship between the image capture circuit and the thermal image capture circuit; and the processor 12 overlapping the first contour onto the position as the second contour.

In some embodiments, while capturing the thermal image, the camera 14 first measures thermal signals in the environment and then normalizes the thermal signals to calculate the temperature value corresponding to each of the pixels in the thermal image.

Specifically, the processor 12 captures a highest thermal signal and a lowest thermal signal from a plurality of thermal signals in the thermal image; and the processor 12 normalizes the thermal signals based on the highest thermal signal and the lowest thermal signal to generate the temperature values.

In summary, the temperature detection apparatus 1 provided by the present disclosure is able to recognize the position of the object in the image and further obtain and record the temperature of the object at the corresponding position in the thermal image. Accordingly, combining the function of recognizing the object in the image and the temperature recorded in the thermal image, the temperature detection apparatus 1 is able to record the object temperature automatically and without manual operation. In addition, the temperature detection apparatus 1 is also able to match the position of the object by the contour of the object, confirm the position of the specific component, and record the temperature of the component. Furthermore, the temperature detection apparatus 1 further comprises a user interface to provide the user to adjust the field of view and zoom of the camera 14.

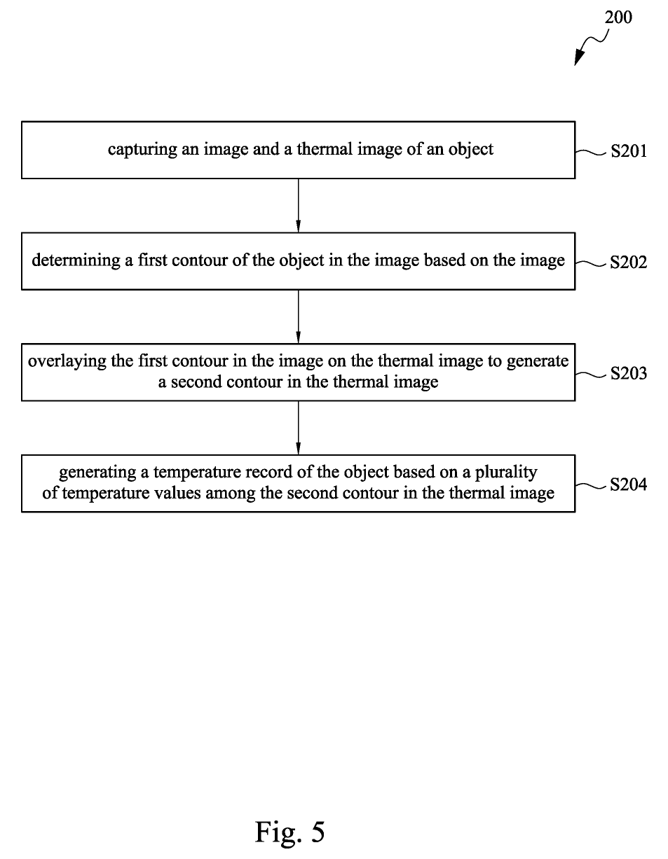

Please refer to FIG. 5, which is a flow diagram illustrating a temperature detection method 200 according to a second embodiment of the present disclosure. The temperature detection method 200 comprises steps S201-S204. The temperature detection method 200 is configured to record temperature of an object based on an image and a thermal image of the object, wherein the object may be a facility, a component of a facility, or part of the component or the facility (e.g., electrical relay). The temperature detection method 200 can be executed by an electrical apparatus (e.g., the temperature detection apparatus 1 in the first embodiment).

In some embodiments, the electronic apparatus comprises a camera (e.g., the camera 14 in the first embodiment) and a processor (e.g., the processor 12 in the first embodiment).

First, in the step S201, the electronic apparatus captures an image and a thermal image of an object.

Next, in the step S202, the electronic apparatus determines a first contour of the object in the image based on the image.

Next, in the step S203, the electronic apparatus overlaps the first contour in the image onto the thermal image to generate a second contour in the thermal image.

Finally, in the step S204, the electronic apparatus generates a temperature record of the object based on a plurality of temperature values among the second contour in the thermal image.

In some embodiments, the step S202 further comprises the electronic apparatus recognizing an object image in the image by using an image recognizing model; and the electronic apparatus generating the first contour on the object image.

In some embodiments, the step of generating the first contour on the object image further comprises the electronic apparatus overlapping a contour template onto the object image to generate the first contour.

In some embodiments, the step S204 further comprises the electronic apparatus retrieving a component temperature corresponding to a mark in the contour template from the temperature values based on the mark in the contour template; and the electronic apparatus generating the temperature record based on the component temperature.

In some embodiments, the step S202 further comprises the electronic apparatus calculating a similarity between the image and a contour template based on the contour template; and in response to the similarity being lower than a threshold, the electronic apparatus not determining the first contour of the object in the image.

In some embodiments, the step S202 further comprises the electronic apparatus displaying a user interface, wherein the user interface comprises the image and a contour template; and the electronic apparatus receiving an operating input corresponding to the user interface, adjusting a field of view (FOV) of the camera capturing the image to determine the first contour.

In some embodiments, the step S202 further comprises the electronic apparatus calculating an area of the object placed in the image based on the image; and the electronic apparatus displaying an indicator in the user interface to guide a user to move the contour template to the area.

In some embodiments, the temperature detection method 200 further comprises the electronic apparatus selecting one of a plurality of candidate templates as the contour template based on positioning information corresponding to the temperature detection apparatus.

In some embodiments, the step S204 further comprises the electronic apparatus selecting a component temperature from the temperature values in a contour template based on a component relative position of the object; and the electronic apparatus generating the temperature record based on the component temperature.

In some embodiments, the electronic apparatus further comprises an image capture circuit configured to capture the image and a thermal image capture circuit configured to capture the thermal image.

In some embodiments, the step S203 further comprises the electronic apparatus determining a position of the first contour in the thermal image based on a positional relationship between the image capture circuit and the thermal image capture circuit; and the electronic apparatus overlapping the first contour onto the position as the second contour.

In some embodiments, the temperature detection method 200 further comprises the electronic apparatus capturing a highest thermal signal and a lowest thermal signal from a plurality of thermal signals in the thermal image; and the electronic apparatus normalizing the thermal signals based on the highest thermal signal and the lowest thermal signal to generate the temperature values.

In summary, the temperature detection method 200 provided by the present disclosure is able to recognize the position of the object in the image and further obtain and record the temperature of the object at the corresponding position in the thermal image. Accordingly, combining the function of recognizing the object in the image and the temperature recorded in the thermal image, the temperature detection method 200 is able to record the object temperature automatically and without manual operation. In addition, the temperature detection method 200 is also able to match the position of the object by the contour of the object, confirm the position of the specific component, and record the temperature of the component. Furthermore, the temperature detection method 200 further comprises a user interface to provide the user to adjust the field of view and zoom of a camera.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A temperature detection apparatus, comprising:
a camera, configured to capture an image and a thermal image of an object; and
a processor, coupled to the camera, configured to execute the following operations:
determining a first contour of the object in the image based on the image;
overlapping the first contour in the image onto the thermal image to generate a second contour in the thermal image; and
generating a temperature record of the object based on a plurality of temperature values among the second contour in the thermal image.

2. The temperature detection apparatus of claim 1, wherein the operation of determining the first contour of the object in the image further comprises:
recognizing an object image in the image by using an image recognizing model; and
generating the first contour on the object image.

3. The temperature detection apparatus of claim 2, wherein the operation of generating the first contour on the object image further comprises:
overlapping a contour template onto the object image to generate the first contour.

4. The temperature detection apparatus of claim 3, wherein the operation of generating the temperature record of the object further comprises:
retrieving a component temperature corresponding to a mark in the contour template from the temperature values based on the mark in the contour template; and
generating the temperature record based on the component temperature.

5. The temperature detection apparatus of claim 1, wherein the operation of determining the first contour of the object in the image further comprises:
calculating a similarity between the image and a contour template based on the contour template; and
in response to the similarity being lower than a threshold, not determining the first contour of the object in the image.

6. The temperature detection apparatus of claim 1, wherein the operation of determining the first contour of the object in the image further comprises:
displaying a user interface, wherein the user interface comprises the image and a contour template; and
receiving an operating input corresponding to the user interface, adjusting a field of view (FOV) of the camera capturing the image to determine the first contour.

7. The temperature detection apparatus of claim 6, wherein the operation of determining the first contour of the object in the image further comprises:
calculating an area of the object placed in the image based on the image; and
displaying an indicator in the user interface to guide a user to move the contour template to the area.

8. The temperature detection apparatus of claim 1, wherein the operation of generating the temperature record of the object further comprises:
selecting a component temperature from the temperature values in a contour template based on a component relative position of the object; and
generating the temperature record based on the component temperature.

9. The temperature detection apparatus of claim 1, wherein the camera further comprises:
an image capture circuit, configured to capture the image; and
a thermal image capture circuit, configured to capture the thermal image;
wherein the operation of overlapping the first contour in the image onto the thermal image further comprises:
determining a position of the first contour in the thermal image based on a positional relationship between the image capture circuit and the thermal image capture circuit; and
overlapping the first contour onto the position as the second contour.

10. The temperature detection apparatus of claim 1, wherein the processor is further configured to execute the following operations:
capturing a highest thermal signal and a lowest thermal signal from a plurality of thermal signals in the thermal image; and
normalizing the thermal signals based on the highest thermal signal and the lowest thermal signal to generate the temperature values.

11. A temperature detection method, being adapted for use in an electronic apparatus, wherein the temperature detection method comprises the following steps:
capturing an image and a thermal image of an object;
determining a first contour of the object in the image based on the image;
overlapping the first contour in the image onto the thermal image to generate a second contour in the thermal image; and
generating a temperature record of the object based on a plurality of temperature values among the second contour in the thermal image.

12. The temperature detection method of claim 11, wherein the step of determining the first contour of the object in the image further comprises:
recognizing an object image in the image by using an image recognizing model; and
generating the first contour on the object image.

13. The temperature detection method of claim 12, wherein the step of generating the first contour on the object image further comprises:
overlapping a contour template onto the object image to generate the first contour.

14. The temperature detection method of claim 13, wherein the step of generating the temperature record of the object further comprises:
retrieving a component temperature corresponding to a mark in the contour template from the temperature values based on the mark in the contour template; and
generating the temperature record based on the component temperature.

15. The temperature detection method of claim 11, wherein the step of determining the first contour of the object in the image further comprises:
calculating a similarity between the image and a contour template based on the contour template; and
in response to the similarity being lower than a threshold, not determining the first contour of the object in the image.

16. The temperature detection method of claim 11, wherein the step of determining the first contour of the object in the image further comprises:
displaying a user interface, wherein the user interface comprises the image and a contour template; and
receiving an operating input corresponding to the user interface, adjusting a field of view (FOV) of a camera capturing the image to determine the first contour.

17. The temperature detection method of claim 16, wherein the step of determining the first contour of the object in the image further comprises:
calculating an area of the object placed in the image based on the image; and
displaying an indicator in the user interface to guide a user to move the contour template to the area.

18. The temperature detection method of claim 11, wherein the step of generating the temperature record of the object further comprises:
selecting a component temperature from the temperature values in a contour template based on a component relative position of the object; and
generating the temperature record based on the component temperature.

19. The temperature detection method of claim 11, wherein the electronic apparatus further comprises:
an image capture circuit, configured to capture the image; and
a thermal image capture circuit, configured to capture the thermal image;
wherein the step of overlapping the first contour in the image onto the thermal image further comprises:
determining a position of the first contour in the thermal image based on a positional relationship between the image capture circuit and the thermal image capture circuit; and
overlapping the first contour onto the position as the second contour.

20. The temperature detection method of claim 11, further comprising:
capturing a highest thermal signal and a lowest thermal signal from a plurality of thermal signals in the thermal image; and
normalizing the thermal signals based on the highest thermal signal and the lowest thermal signal to generate the temperature values.
